(19) United States
(12) Patent Application Publication
(10) Pub. No.: US 2002/0199129 A1
(43) Pub. Date: Dec. 26, 2002

(54) Data storage on a computer disk array

(75) Inventors: Patrick J. Bohrer, Austin, TX (US); Elmootazbellah N. Elnozahy, Austin, TX (US); Charles R. Lefurgy, Round Rock, TX (US); Ramakrishnan Rajamony, Austin, TX (US); Bruce A. Smith, Austin, TX (US)

Correspondence Address: Frank C. Nicholas, CARDINAL LAW GROUP, Suite 2000, 1603 Orrington Avenue, Eanston, IL, 60201, US

(73) Assignee: International Business Machines Corp., Armonk, NY (US)

(21) Appl. No.: 09/886,192

(22) Filed: Jun. 21, 2001

(51) Int. Cl. H04L 1/22

(52) U.S. Cl. 714/7

(57) ABSTRACT

A method and a computer usable medium including a program for operating a plurality of disks. Units of data storage are selected. The disks are allocated between an active group and an inactive group. The units of data storage having a usage factor that meets a condition limit are allocated to the active group. The units of data storage having a usage factor not meeting the condition limit are allocated to the inactive group. The disks are selectively reallocated between the active group and the inactive group based upon a disk use parameter.

### TECHNICAL FIELD OF THE INVENTION

The present invention relates to computer disk operation and, more specifically, to a method for allocating files on an array of computer disks.

### BACKGROUND OF THE INVENTION

Computer systems generally use arrays of disk drives to improve storage performance and reliability. For example, Redundant Arrays of Inexpensive Disks (RAID) have become very popular in server farms. Other configurations are also possible, for instance by spreading a storage volume that logically appears as a single logical disk over several disks. The stored files typically are allocated evenly between several hard disk drives within a computer system, such as in RAID systems, or with no specific distribution as in multi-disk storage volumes.

In dense server systems where maintenance costs are high and power consumption matters, this storage methodology has several shortcomings. For example, RAID systems require all disks to be accessed simultaneously to improve performance and reliability, requiring the entire disk farm to be always online. This leads to high power consumption. A superior solution would allocate files such that not all disks need to be accessed simultaneously, allowing a part of the disk farm to be turned off to reduce power consumption. Thus, disks capable of periodically turning off can save power and extend a mean time to failure (MTTF). For example, laptop computer systems require small hard disks that optimize energy usage. Thus, laptop disks are designed for frequent spin up-and-down cycles and extended off-times. A superior method of allocating files across the array would exploit such disks in server farms or general computing systems and may also utilize power management to effectively reduce power consumption and overall wear.

Switching parts of the disk farm on and off frequently, however, may lead to imbalances in the workloads of individual disks. This imbalance may lead to an increased and uneven drive wear and tear, driving up the maintenance cost of the server farm. A superior method of allocating files across the array would ensure balanced disk wear without sacrificing the power reduction advantages of switching parts of the disk farm off.

In summary, the disk storage architecture of computer systems provides high performance and reliability. The current storage methodology, however, has limitations that may include unbalanced and increased disk wear and high power consumption. Therefore, it would be desirable to achieve a strategy for operating an array of computer disks that overcomes the aforementioned and other disadvantages.

### SUMMARY OF THE INVENTION

One aspect of the invention provides a method of operating a plurality of disks. Units of data storage are selected. The disks are allocated between an active group and an inactive group. The units of data storage having a usage factor that meets a condition limit are allocated to the active group. The units of data storage having a usage factor not meeting the condition limit are allocated to the inactive group. The disks are selectively reallocated between the active group and the inactive group based upon a disk use parameter. The disks may be classified into a plurality of disk groups, including said active group and said inactive group. The classification of the disk groups may comprise assigning each disk to the active group based on required performance, power consumption, and desire to reduce and balance the wear within the disk groups. Determining the usage factor may comprise determining a unit access parameter; the access parameter may comprise file popularity. The usage factor may classify each unit based on whether the unit meets a conditional limit. A total storage requirement may be computed for each unit that meets the condition limit. The active group may be determined based on the condition limit and the total storage requirement. The condition limit may be determined based on the usage factors. Each unit meeting the condition limit may be allocated evenly among the active group; each unit not meeting the condition limit may be allocated evenly among the inactive group. Allocating each unit may comprise assigning and storing the unit. Units may be transferred between the active and inactive disk groups whenever disks are reallocated between the two groups. Disks may be periodically reassigned into one of the active group or inactive group wherein the periodic reassignment may be based on required performance, power consumption, and desire to reduce and balance the wear within the disk groups. Controlling the duty cycle may comprise controlling the starting and stopping of the disks.

Another aspect of the invention provides a computer usable medium including a program for operating a plurality of disks comprising: computer readable program code for selecting units of data storage, computer readable program code for allocating the disks between an active group and an inactive group, computer readable program code for allocating units of data storage having a usage factor that meets the condition limit to the active group, computer readable program code for allocating units of data storage having a usage factor not meeting the condition limit to the inactive group, and computer readable program code for selectively reallocating disk between the active group and the inactive group based upon a disk use parameter.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic overview of one embodiment of the present invention; and

FIG. 2 is a flow diagram of an algorithm according to another embodiment of the present invention.

### DETAILED DESCRIPTION OF THE PRESENTLY PREFERRED EMBODIMENTS

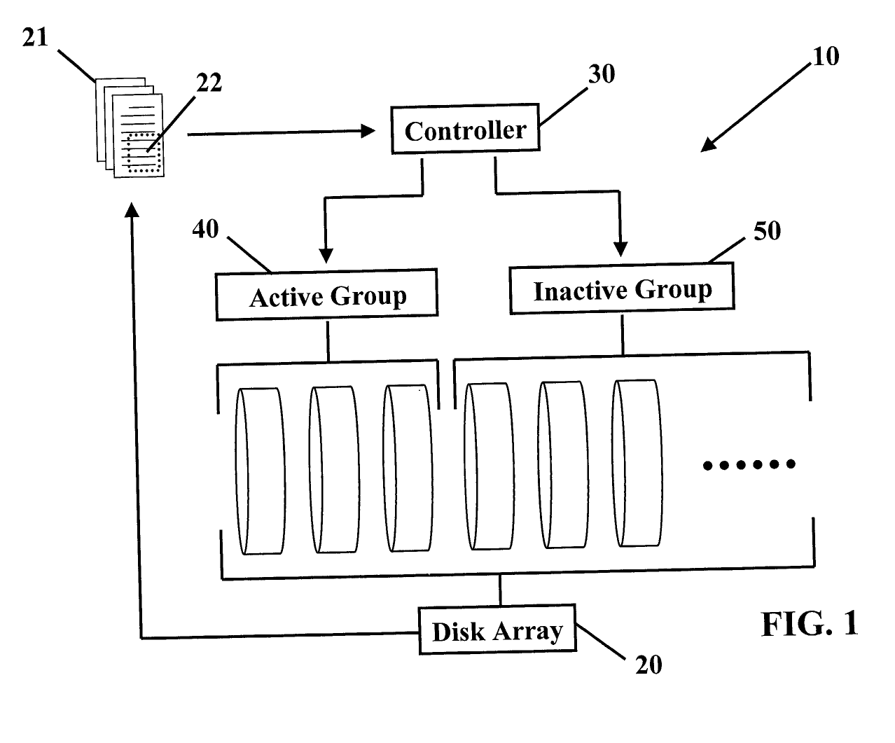

Referring to the drawings, FIG. 1 shows a schematic overview of one embodiment of the present invention designated in the aggregate as numeral 10. In one embodiment, a computer system (not shown) may support an array of disks 20. Those skilled in the art will appreciate that any number of computer hard drive type disks may be suitable for use with the present invention. For example, 3.5-inch form factor type hard drives, 1.8-inch and 2.5-inch form factor laptop type hard drives, and combinations thereof may be functionally adapted for use with the present invention.

The unit of storage of data allocation in the following description is set to a file. Those skilled in the art will appreciate that the same method can be applied to other units of storage allocation in a straightforward manner (e.g. disk block, file system block, portion of a file, a combination of files, database indexes, etc.). In one embodiment, a plurality of files 21 containing data may be stored on the disks 20. The computer system may be attached to a network wherein the files 21 may be accessed. Furthermore, the files 21 may be modified in number, size, or characteristic through the computer system and other networked computers.

The files 21 may contain file characteristics 22 such as a file size and an access parameter that may be relayed to a controller 30. The file size may reflect the byte count size of the file. The access parameter may reflect any number of statistics relating to file popularity. The file popularity may be determined by a file access count, a file access rate, a file recent usage rate, or a file access rank. Determining the file popularity may involve counting number of file accesses to calculate the file access count and optionally dividing by a time, t, to calculate the file access rate. In one embodiment, the file popularity may be estimated by ranking the access count of the files 21 to determine the file access rank. Files 21 with the greatest access counts may be designated as most popular.

The controller 30 may classify the array of disks into a plurality of disk groups. In one embodiment, the disk groups may include an active group 40 and an inactive group 50. The controller 30 may assign each disk to either the active group or the inactive group based on required performance, power consumption, and desire to reduce and balance the wear within the disk groups. This classification and assignment process may be better understood by the following description of controller 30 function.

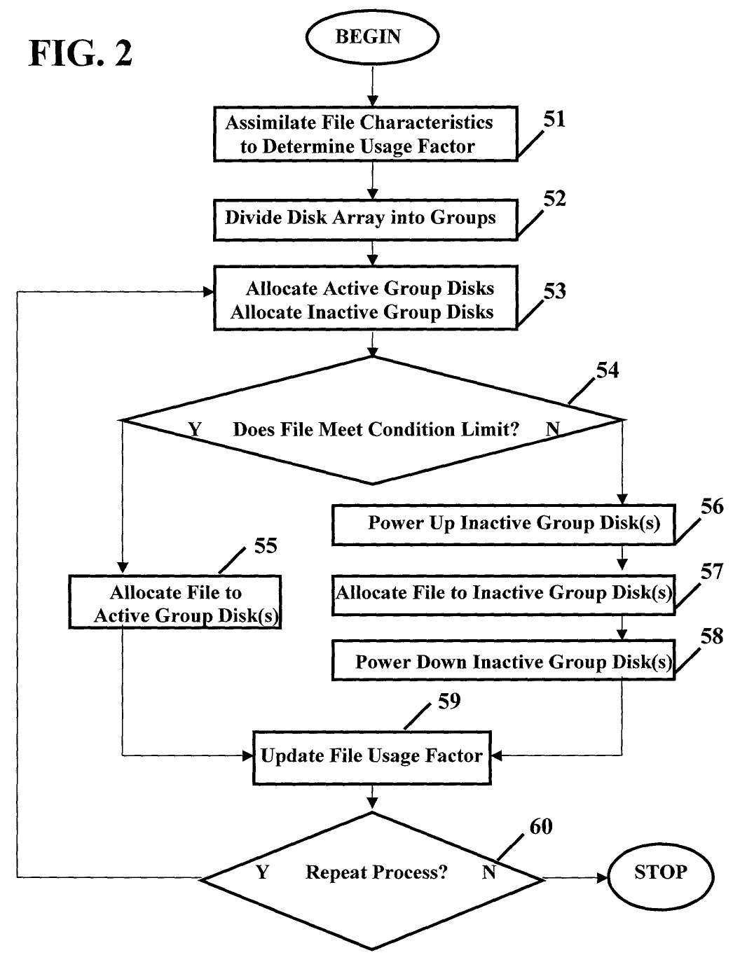

One embodiment of the invention in which an algorithm for operating a plurality of disks is shown in FIG. 2. The algorithm may be written in computer readable program code and run by the controller 30. In another embodiment, the server and/or the disks may run the algorithm. Those skilled in the art will recognize that a number of strategies exist for operating the disks in a manner consistent with the present invention. The outlined steps of the algorithm may be modified in number, order, or content while maintaining effective operation of the disk array.

As shown in FIG. 2, the aforementioned file characteristic information 22 may be assimilated to determine a usage factor for each file (block 51). Δ controller may then divide the array of disks into a plurality of groups (block 52). In one embodiment, the groups may comprise an active group and an inactive group. Each disk may then be allocated to either the active group or the inactive group (block 53). In one embodiment, the disk allocation may be based on number of file usage factors meeting a condition limit. For example, those skilled in the art will appreciate that 10 percent of files generally comprise 90 percent of total access operations. Files falling into a 10 percent access usage factor category may meet the condition limit. In one embodiment, the controller may estimate a storage size needed to hold files meeting the condition limit, such as the 10 percent category, and an appropriate number of disks may be allocated to the active group to accommodate these files.

In another embodiment, the active group and the inactive group disks may be allocated (block 53) based on a predetermined rule set by an operator of the server or the controller. In yet another embodiment, the active group and inactive group disks may be allocated based on a tradeoff of performance, power consumption, and a desire to extend the MTTF of the disk array components. At one extreme, a large number of disks allocated to the active group may yield better performance, but at the expense of higher power consumption and shorter MTTF. At the other extreme, a small number of disks allocated to the active group may reduce performance, but will lower power consumption and extend the MTTF. Therefore, the active group and the inactive group may be allocated to optimize performance, power consumption, and MTTF.

Once the disks have been allocated into either the active group or the inactive (block 53), the controller may determine whether a file meets the condition limit based on the file usage factor. The condition limit may be designated by the aforementioned 90-10 rule, based on the storage capacity of the active group, or determined by a predetermined rule set by an operator of the server or the controller. The condition limit may not only be used to determine the files comprising the active group, but also the number of disks needed to store these files. If a file meets the condition limit (block 54), it may be allocated onto at least one active group disk (blocks 55). Conversely, if a file does not meet the condition limit (block 54), at least one inactive group disk may be powered up (block 56) and the file may be allocated onto those disk(s) (block 57).

The controller may repeat the file allocation process for every file or subset of files stored on the disk array. In addition, the controller may determine which disk(s) are to be powered up and down and/or which disk(s) are to take part in the file allocation process. For example, a file may span two or more disks within a given group (the group in which the file has been determined to be part of). In one embodiment, the controller may ensure that the correct disks within the given group are ‘on’ and accessible to allow for the allocation of said file.

The allocation of files (blocks 55 and 57) may comprise spreading the files evenly across the appropriate disk group. Allocating the files evenly across the appropriate disk group may ensure balanced disk wear and may be accomplished by assigning, copying, and storing the files to a designated disk. The allocation process may allow traditional parallel access methods, such as RAID to be applied within the context and scope of the active disk group.

To reduce system power consumption and overall disk wear, the controller may control and manage a spin on-off duty cycle of individual or group of disks. Those skilled in the art will recognize that a variety of hard drive technologies support efficient and reliable on-off duty cycles. Examples include the aforementioned laptop disk drives. After the file allocation process of the inactive group disk(s) (block 57), the powered up inactive group disks may be powered down (block 58) until another file access procedure is required. Power may be conserved and overall wear reduced since only the majority of active group disks are ‘on’ and actively accessed. In one embodiment, the active group disks may also be powered up and down as required by the controller. Powering down at least one active group disk may save additional power and wear.

Controlling the duty cycle may comprise controlling the starting and stopping of the disks. In one embodiment, the process may be contingent upon such factors as reducing power consumption, improving system performance, and a desire to balance the workload over time. Balancing the workload across the disks may avoid creating excessive wear within a subset of the disk farm. Thus, disks in the active group may periodically move to the inactive group, and disks in the inactive group may periodically move to the active group in a manner that balances the wear on the disks over the time of the disk farm's operation. Files may be allocated to the new active disks upon such a transition. For example, inactive group files may be re-allocated to the new inactive group disks. The frequency of such transition may be managed by the controller in a manner that reduces the impact on the overall storage performance and power consumption, while maintaining the balance in the workload over a long period of time.

After the file allocation process for both the active and inactive group disks, the file usage factor may be updated (block 59). In one embodiment, the controller may update the file usage factor as the file is accessed during a system operation or access procedure. After updating the file usage factor, a portion of the disk control process may or may not be repeated (block 60). If the process it not to be repeated, the algorithm may cease at this point. The operator of the system or the controller may choose to re-start the procedure at a later time. If the disk control process is to be repeated, the active group and inactive group disks may be re-allocated (block 53). The re-allocation may be based on a disk use parameter. The disk use parameter may be provided by the operator of the system or determined by the controller. In one embodiment, the disk use parameter may reflect a change in the file number or characteristics or the need to balance drive wear. Re-allocation provides several advantages, including: a refinement of the active and inactive groups, both in terms of disk assignment to a group and file allocation to a group, a dynamic adjustment in the face of changing file access patterns, and alternating group membership of the disks.

In one embodiment, the inactive group disk(s) may periodically join the active group, and active group disk(s) may join the inactive group. Rotating the membership of active group via re-allocation may balance wear on the disk array and avoid creating imbalances in the workload. Furthermore, since the inactive group disks are generally turned off, they would not consume power and their MTTF may be extended. Rotating group membership may entail that files in a current active group are reallocated to disks that would soon be designated to a new active group. Similarly, files in a current inactive group are reallocated to disks that would soon be designated to a new inactive group. Finally, the disks remaining in a respective active or inactive group would not require their files to be reallocated. This file reallocation allows disks to rotate between the ‘on’ state and ‘off’ state, while attempting to balance the entire workload over all disks to reduce the overall wear in the disk array.

The membership of the active group may be re-allocated frequently and may rotate within the disk array to ensure a most balanced wear between drive members as needed. In one embodiment, the controller may repeat the re-allocation and aforementioned procedural loop indefinitely to control the operation of the disk array. A timer (not shown) set by an operator of the system or the controller may dictate the loop cycle as a whole or by individual step. The timer may ensure steady and continuous controller operation as well as operable flexibility. Additionally, the timer information may be utilized for the file access count and rate determinations.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of operating a plurality of disks comprising:
selecting units of data storage;
allocating the disks between an active group and an inactive group;
allocating units of data storage having a usage factor that meets the condition limit to the active group;
allocating units of data storage having a usage factor not meeting the condition limit to the inactive group; and
selectively reallocating disk between the active group and the inactive group based upon a disk use parameter.

2. The method of claim 1 further comprising classifying the disks into a plurality of disk groups, including said active group and said inactive group.

3. The method of claim 2 wherein the classifying the disk groups comprises assigning each disk to the active group based on required performance, power consumption, and desire to reduce and balance the wear within the disk groups.

4. The method of claim 1 wherein determining the usage factor comprises determining a unit access parameter.

5. The method of claim 4 wherein the access parameter comprises file popularity.

6. The method of claim 1 wherein the usage factor classifies each unit based on whether the unit meets a conditional limit.

7. The method of claim 6 wherein a total storage requirement is computed for each unit that meets the condition limit.

8. The method of claim 7 wherein the active group is determined based on the condition limit and the total storage requirement.

9. The method of claim 1 wherein the condition limit is determined based on the usage factors.

10. The method of claim 1 wherein each unit meeting the condition limit is allocated evenly among the active group.

11. The method of claim 1 wherein each unit not meeting the condition limit are allocated evenly among the inactive group.

12. The method of claim 1 wherein allocating each unit comprises assigning and storing the unit.

13. The method of claim 12 further comprising transferring units between the active and inactive disk groups whenever disks are reallocated between the two groups.

14. The method of claim 12 further comprising periodically reassigning of disks into one of the active group or inactive group.

15. The method of claim 14 wherein the periodic reassignment is based on required performance, power consumption, and desire to reduce and balance the wear within the disk groups.

16. The method of claim 1 wherein controlling the duty cycle comprises controlling the starting and stopping of the disks.

17. A computer usable medium including a program for operating a plurality of disks comprising:
computer readable program code for selecting units of data storage;
computer readable program code for allocating the disks between an active group and an inactive group;
computer readable program code for allocating units of data storage having a usage factor that meets the condition limit to the active group;
computer readable program code for allocating units of data storage having a usage factor not meeting the condition limit to the inactive group; and
computer readable program code for selectively reallocating disk between the active group and the inactive group based upon a disk use parameter.

18. The computer usable medium of claim 17 further comprising classifying the disks into a plurality of disk groups, including said active group and said inactive group.

19. The computer usable medium of claim 18 wherein the classifying the disk groups comprises assigning each disk to the active group based on required performance, power consumption, and desire to reduce and balance the wear within the disk groups.

20. The computer usable medium of claim 17 wherein determining the usage factor comprises determining a unit access parameter.

21. The computer usable medium of claim 20 wherein the access parameter comprises file popularity.

22. The computer usable medium of claim 17 wherein the usage factor classifies each unit based on whether the unit meets a conditional limit.

23. The computer usable medium of claim 22 wherein a total storage requirement is computed for each unit that meets the condition limit.

24. The computer usable medium of claim 23 wherein the active group is determined based on the condition limit and the total storage requirement.

25. The computer usable medium of claim 17 wherein the condition limit is determined based on the usage factors.

26. The computer usable medium of claim 17 wherein each unit meeting the condition limit is allocated evenly among the active group.

27. The computer usable medium of claim 178 wherein each unit not meeting the condition limit are allocated evenly among the inactive group.

28. The computer usable medium of claim 17 wherein allocating each unit comprises assigning and storing the unit.

29. The computer usable medium of claim 28 further comprising transferring units between the active and inactive disk groups whenever disks are reallocated between the two groups.

30. The computer usable medium of claim 28 further comprising periodically reassigning of disks into one of the active group or inactive group.

31. The computer usable medium of claim 30 wherein the periodic reassignment is based on required performance, power consumption, and desire to reduce and balance the wear within the disk groups.

32. The computer usable medium of claim 17 wherein controlling the duty cycle comprises controlling the starting and stopping of the disks.

33. A system for operating disks having files comprising:
means for selecting units of data storage;
means for allocating the disks between an active group and an inactive group;
means for allocating units of data storage having a usage factor that meets the condition limit to the active group;
means for allocating units of data storage having a usage factor not meeting the condition limit to the inactive group; and
means for selectively reallocating disk between the active group and the inactive group based upon a disk use parameter.
